(19) United States
(12) Patent Application Publication
(10) Pub. No.: US 2026/0132245 A1
(43) Pub. Date: May 14, 2026

(54) PREPREG PRODUCTION METHOD AND MATRIX RESIN RAW MATERIAL COMPOSITION

(71) Applicant: Honda Motor Co., Ltd., Tokyo (JP)

(72) Inventors: Mitsuharu Kan, Saitama (JP); Masaki Namaizawa, Saitama (JP)

(21) Appl. No.: 19/378,499

(22) Filed: Nov. 4, 2025

(30) Foreign Application Priority Data
Nov. 8, 2024 (JP) 2024-195690

(51) Int. Cl. C08G 59/62; C08G 59/22; C08G 59/32; C08J 5/24

(52) U.S. Cl. CPC C08G 59/621; C08G 59/22; C08G 59/32; C08J 5/24; C08J 2363/00

(57) ABSTRACT

A prepreg production method includes: an impregnation step of impregnating a fiber substrate with a matrix resin raw material composition containing a main agent of a matrix resin, a curing agent, and a solvent; and a drying step of drying the matrix resin raw material composition impregnated into the fiber substrate in the impregnation step. The main agent is an epoxy resin. The curing agent is a polyethylene glycol lignin derivative. The solvent includes: a first solvent composed of a glycol ether; and a second solvent composed of an ether.

### CROSS-REFERENCE TO RELATED APPLICATION

This application is based upon and claims the benefit of priority from Japanese Patent Application No. 2024-195690 filed on Nov. 8, 2024, the content of which is incorporated herein by reference.

### BACKGROUND OF THE INVENTION

### Field of the Invention

The present invention relates to a prepreg production prepreg production method in which a fiber substrate is impregnated with a matrix resin containing an epoxy resin as a main agent and a polyethylene glycol (PEG) lignin derivative, which is extracted from Japanese cedar using PEG, as a curing agent, and a matrix resin raw material composition.

### Description of the Related Art

Conventionally, a method for producing a resin composition containing an epoxy resin and a PEG lignin derivative is known. For example, in the production method of JP 2020-203968 A, modified lignin chemically modified with polyethylene glycol is liquefied by being treated in a methanol solvent, mixed with an epoxy resin, and then the obtained solid is dried to remove methanol.

Incidentally, the matrix resin of the prepreg is required to be able to maintain a uniform varnish state in order to sufficiently impregnate the fiber substrate. However, in the case of using methanol as a solvent as in the production method described in JP 2020-203968 A, it is difficult to sufficiently dissolve lignin, and it is difficult to maintain a uniform varnish state in a step of impregnating the fiber substrate.

### SUMMARY OF THE INVENTION

An aspect of the present invention is a prepreg production method, including: an impregnation step of impregnating a fiber substrate with a matrix resin raw material composition containing a main agent of a matrix resin, a curing agent, and a solvent; and a drying step of drying the matrix resin raw material composition impregnated into the fiber substrate in the impregnation step. The main agent is an epoxy resin. The curing agent is a polyethylene glycol lignin derivative. The solvent includes: a first solvent composed of a glycol ether; and a second solvent composed of an ether.

Another aspect of the present invention is a matrix resin raw material composition, including: a main agent; a curing agent; and a solvent. The main agent is an epoxy resin. The curing agent is a polyethylene glycol lignin derivative. The solvent includes: a first solvent composed of a glycol ether; and a second solvent composed of an ether.

### BRIEF DESCRIPTION OF THE DRAWINGS

The objects, features, and advantages of the present invention will become clearer from the following description of embodiments in relation to the attached drawings, in which:

FIG. 1 is a flowchart illustrating an example of a prepreg production method according to an embodiment of the present invention.

### DETAILED DESCRIPTION OF THE INVENTION

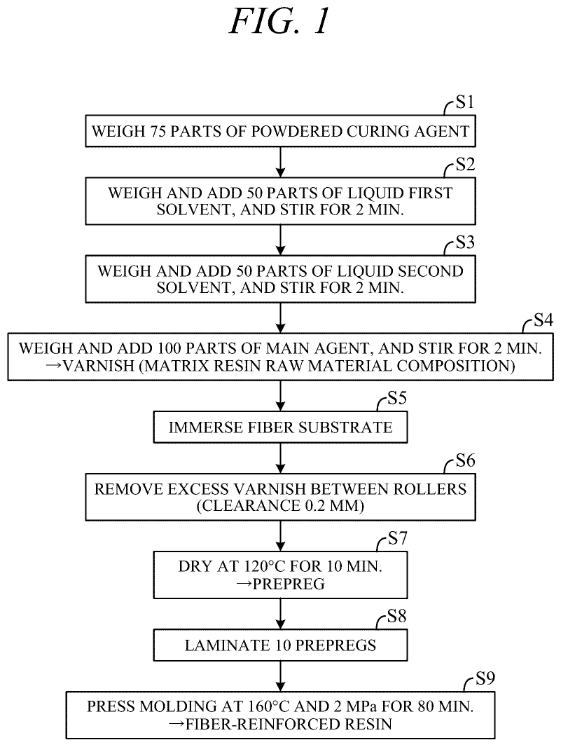

Hereinafter, embodiments of the present invention will be described with reference to FIG. 1. A prepreg according to an embodiment of the present invention is an intermediate material of a fiber-reinforced resin, and is a sheet-shaped material in which a fiber substrate such as a glass fiber is impregnated with a matrix resin. A fiber-reinforced resin can be produced by laminating and press-molding prepregs. The laminated prepregs are bonded to each other by a matrix resin having viscosity. The prepregs thus laminated are press-molded under a temperature condition equal to or higher than a curing temperature of the matrix resin, so that the matrix resin is cured to complete a fiber-reinforced resin.

Typical examples of a thermosetting resin used as the matrix resin include an epoxy resin. As the curing agent of the epoxy resin, a bio-derived PEG lignin derivative can be used. However, the PEG lignin derivative is a powder at normal temperature and is difficult to dissolve. Therefore, in the present embodiment, the PEG lignin derivative is dissolved using an appropriate solvent, and mixed with an epoxy resin to form a matrix resin raw material composition in a state suitable for impregnation into the fiber substrate as follows.

FIG. 1 is a flowchart illustrating an example of a prepreg production method according to an embodiment of the present invention. As illustrated in FIG. 1, in the prepreg production method according to the embodiment of the present invention, first, 75 parts (for example, 585 g) of a powdered PEG lignin derivative is weighed as a curing agent in step S1. As the PEG lignin derivative, for example, SD4 manufactured by LignoMateria as described below can be used.

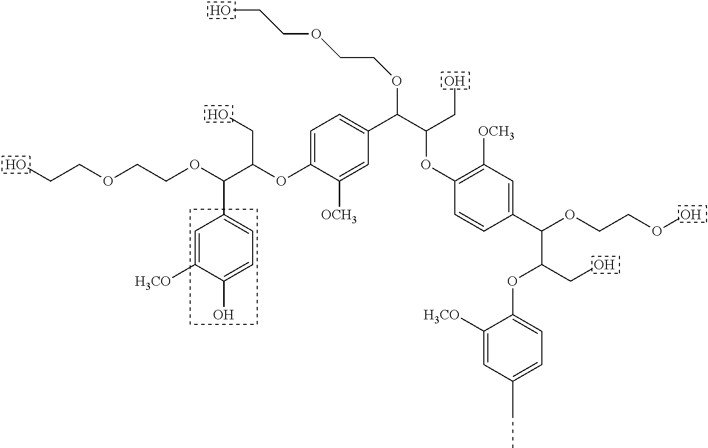

Next, in a first mixing step S2, 50 parts (for example, 390 g) of liquid methyl cellosolve as a first solvent is weighed, poured into the powdered PEG lignin derivative weighed in step S1, added, and stirred with a mixer for 2 minutes. The PEG lignin derivative has a phenol group derived from lignin and a hydroxy group derived from PEG. By selecting a solvent having high compatibility with a phenol group as a solvent and approaching the solvent to the phenol group, the PEG lignin derivative is sufficiently dissolved, and a varnish in a uniform mixed state can be obtained.

As the solvent having high compatibility with a phenol group, a solvent having a solubility parameter SP value closer to 11.5 [cal/cm³]^{1/2} which is the SP value of the phenol group than 14.6 [cal/cm³]^{1/2} which is the SP value of the hydroxy group can be selected. More specifically, a solvent having a solubility parameter SP value of 8 [cal/cm³]^{1/2} or more and 12.5 [cal/cm³]^{1/2} or less can be selected.

AS such a solvent, for example, it is possible to select glycol ethers such as propylene glycol monomethyl ether (CH₃OCH₂CH(CH₃)OH) (boiling point: 120° C.) having an SP value of 11 [cal/cm³]^{1/2}, methyl cellosolve (CH₃OCH₂CH₂OH) (boiling point: 124° C.) having an SP value of 12.1 [cal/cm³]^{1/2}, ethyl cellosolve (C₂H₅OCH₂CH₂OH) (boiling point: 136° C.) having an SP value of 8.9 [cal/cm³]^{1/2}, ethylene glycol tertiary butyl ether (CH₃C(CH₃)₂OCH₂OH) (boiling point: 152° C.) having an SP value of 8.4 [cal/cm³]^{1/2}, butyl cellosolve (C₄H₉OCH₂CH₂OH) (boiling point: 171° C.) having an SP value of 10.2 [cal/cm³]^{1/2}, 3-methoxy-3-methyl-1-butanol (CH₃OC(CH₃)₂CH₂CH₂OH) (boiling point: 174° C.) having an SP value of 8.4 [cal/cm³]^{1/2}, ethylene glycol monopropyl ether (CH₃CH₂CH₂OCH₂CH₂OH) (boiling point: 150° C.) having an SP value of 8.2 [cal/cm³]^{1/2}, diethylene glycol monobutyl ether (C₄H₉O(CH₂CH₂O)₂H) (boiling point: 230° C.) having an SP value of 10.2 [cal/cm³]^{1/2}, triethylene glycol monobutyl ether (C₄H₉O(CH₂CH₂O)₃H) (boiling point: 271° C.) having an SP value of 8.4 [cal/cm³]^{1/2}, and dipropylene glycol monomethyl ether (CH₃O(C₃H₆O)₂H) (boiling point: 188° C.) having an SP value of 8.2 [cal/cm³]^{1/2}, and ethers such as 1,3-dioxolane (C₃H₆O₂) (boiling point: 75° C.) having an SP value of 10.2 [cal/cm³]^{1/2}, 1,4-dioxane (C₄H₈O₂) (boiling point: 101° C.) having an SP value of 10.3 [cal/cm³]^{1/2}, and tetrahydrofuran (THF) (C₄H₈O) (boiling point: 66° C.) having an SP value of 9.3 [cal/cm³]^{1/2}.

The solvent needs to be volatilized and removed in a drying step before press molding. The temperature condition of such a drying step is set according to the boiling point of the solvent. The curing temperature of the matrix resin, that is, the temperature at which the curing reaction between the epoxy resin as a main agent of the matrix resin and the PEG lignin derivative as a curing agent starts is about 140° C. In order to maintain the unreacted state of the matrix resin even after the drying step and maintain the viscosity of the matrix resin, it is necessary to select a solvent having a boiling point lower than the curing temperature. More specifically, a solvent having a boiling point of 140° C. or lower can be selected.

As such a solvent, for example, it is possible to select glycol ethers such as propylene glycol monomethyl ether (SP value: 11 [cal/cm³]^{1/2}), methyl cellosolve (SP value: 12.1 [cal/cm³]^{1/2}), and ethyl cellosolve (SP value: 8.9 [cal/cm³]^{1/2}), and ethers such as 1,3-dioxolane (SP value: 10.2 [cal/cm³]^{1/2}), 1,4-dioxane (SP value: 10.3 [cal/cm³]^{1/2}), and THF (SP value: 9.3 [cal/cm³]^{1/2}). Among these solvents, particularly, a solvent of a glycol ether having an SP value close to 11.5 [cal/cm³]^{1/2}, which is the SP value of a phenol group, for example, methyl cellosolve is selected as the first solvent, whereby the PEG lignin derivative is sufficiently dissolved, and a varnish in a uniform mixed state can be obtained.

Note that, as a solvent for the PEG lignin derivative, N,N-dimethylformamide (formyldimethylamine, DMF) (boiling point: 153° C.), dimethyl sulfoxide (DMSO) (boiling point: 189° C.), N-methyl-2-pyrrolidone (NMP) (boiling point: 202° C.), N,N-dimethylacetamide (DMAc) (boiling point: 165° C.), and the like are known, and these solvents have a boiling point higher than the curing temperature (140° C.). For example, the SP value of DMSO is 14.5 [cal/cm³]^{1/2}, which is closer to 14.6 [cal/cm³]^{1/2} that is the SP value of the hydroxy group than 11.5 [cal/cm³]^{1/2} that is the SP value of the phenol group. Similarly, the SP value of methanol, which is known as a solvent for PEG lignin derivatives, is 14.5 [cal/cm³]^{1/2}, which is close to the SP value of the hydroxy group.

Next, in a second mixing step S3, 50 parts (for example, 390 g) of liquid THF as the second solvent is weighed, added to the mixed composition (varnish) of the curing agent and the first solvent obtained in the first mixing step S2, and stirred with a mixer for 2 minutes. As the second solvent, among glycol ethers and ethers having high compatibility with the phenol group, ethers having a relatively low boiling point, more specifically, 1,3-dioxolane (boiling point: 75° C.), 1,4-dioxane (boiling point: 101° C.), and THF (boiling point: 66° C.) which have a boiling point of 25° C. or higher and 110° C. or lower, for example, THF having a particularly low boiling point can be selected.

As described above, by adding the second solvent having a low boiling point to the varnish which is the mixed composition of the curing agent and the first solvent, not only the curing agent is further dissolved, but also the first solvent is diluted, and the boiling point of the solvent as a whole, which is a combination of the first solvent and the second solvent, can be lowered. When the boiling point of the solvent as a whole is high, the solvent is not completely volatilized depending on the temperature condition of the drying step and the like, and a part of the solvent may remain even after the drying step. By lowering the boiling point of the solvent as a whole, the solvent can be completely volatilized and removed in the drying step.

Next, in step S4, 100 parts (for example, 780 g) of a liquid epoxy resin as the main agent is weighed, added to the mixed composition (varnish) of the curing agent and the solvents (the first solvent and the second solvent) obtained in the second mixing step S3, and stirred with a mixer for 2 minutes. As the epoxy resin, for example, sorbitol glycidyl ether such as DENACOL EX-614B manufactured by Nagase ChemteX Corporation can be used. As the epoxy resin, limonene dioxide such as CELLOXIDE 3000 manufactured by Daicel Corporation, epoxidized soybean oil such as ADK CIZER O-130P manufactured by ADEKA CORPORATION and SANSO CIZER E-2000H manufactured by New Japan Chemical Co., Ltd., epoxidized castor oil such as EPOX MK R151 manufactured by Printec Corporation, epoxidized linseed oil such as ADK CIZER O-180A manufactured by ADEKA CORPORATION and SANSO CIZER E-9000H manufactured by New Japan Chemical Co., Ltd., and the like can also be used. Hereinafter, the mixed composition (varnish) of the curing agent, the solvents (the first solvent and the second solvent), and the main agent obtained in the mixing steps S1 to S4 may be referred to as “matrix resin raw material composition”.

Next, in an impregnation step S5, one fiber substrate is immersed in the varnish which is the matrix resin raw material composition obtained in the mixing steps S1 to S4, and the fiber substrate is impregnated with the varnish. As the fiber substrate, for example, a glass fiber woven fabric such as glass cloth of 7628WLA209 105BZ or the like manufactured by Nitto Boseki Co., Ltd. can be used. As the fiber substrate, in addition to the glass fiber woven fabric, a glass fiber nonwoven fabric, a glass fiber mat, a carbon fiber woven fabric, a carbon fiber nonwoven fabric, a carbon fiber mat, an aramid fiber woven fabric, an aramid fiber nonwoven fabric, an aramid fiber mat, a vegetable fiber woven fabric, a vegetable fiber nonwoven fabric, a vegetable fiber mat, paper, and the like can also be used.

When the entire solvent is composed only of an ether having a low boiling point (for example, THF having a boiling point of 66° C.), the solvent is volatilized and lost even in the impregnation step S5, and the viscosity of the varnish may be increased. When the viscosity of the varnish increases at a stage where the impregnation into the fiber substrate is insufficient, the impregnation of the varnish into the fiber substrate does not proceed thereafter, and there is a possibility that a portion not impregnated with the varnish may occur in the fiber substrate. By blending an ether having a relatively low boiling point (having a boiling point of 25° C. or higher and 110° C. or lower, for example, THF having a boiling point of 66° C.) and a glycol ether having a relatively high boiling point (having a boiling point of 120° C. or higher and 140° C. or lower, for example, methyl cellosolve having a boiling point of 124° C.) in a well-balanced manner (for example, in the same amount) and using the mixture as a solvent, it is possible to prevent volatilization of the entire amount of the solvent in the middle of the impregnation step and to maintain a uniform varnish state in the entire impregnation step.

Next, in step S6, the fiber substrate impregnated with the matrix resin raw material composition (varnish) in the impregnation step S5 is passed between rollers with a clearance set to 0.2 mm, and excess varnish is squeezed off and removed.

Next, in a drying step S7, the matrix resin raw material composition (varnish), which has been impregnated into the fiber substrate in the impregnation step S5 and partially removed in step S6, is dried to volatilize and remove the solvents (the first solvent and the second solvent). More specifically, the fiber substrate impregnated with the matrix resin raw material composition is dried in a drying furnace at 120° C. for 10 minutes. When the solvent contained in the matrix resin raw material composition is volatilized and removed, a prepreg in which the fiber substrate is impregnated with the matrix resin composition that is a mixed composition of the curing agent and the main agent is obtained.

By blending a glycol ether having a relatively high boiling point (for example, methyl cellosolve having a boiling point of 124° C.) and an ether having a relatively low boiling point (for example, THF having a boiling point of 66° C.) in a well-balanced manner (for example, in the same amount) and using the mixture as a solvent, the solvent can be volatilized and removed in a relatively short time (for example, 10 minutes) even under a relatively mild temperature condition (for example, 120° C.). For example, at about 120° C. lower than the curing temperature, when the entire amount of the solvent is methyl cellosolve having a boiling point of 124° C., it takes a long time to dry the solvent, but when the half amount of the solvent is THE having a boiling point of 66° C., it is possible to shorten the time required for drying.

Next, in a lamination step S8, the prepregs obtained in the drying step S7 are laminated (for example, 10 prepregs are laminated). The laminated prepregs are bonded to each other by a matrix resin having viscosity.

Next, in a press molding step S9, the prepregs laminated in the lamination step S8 are press-molded at 160° C. and 2 MPa for 80 minutes. The matrix resin is cured by press-molding under a temperature condition equal to or higher than a curing temperature (140° C.) of the matrix resin, thereby obtaining a fiber-reinforced resin in which the laminated prepregs are integrated.

According to the embodiment of the present invention, the following operation and effect are achievable.
(1) The prepreg production method includes: an impregnation step S5 of impregnating a fiber substrate with a matrix resin raw material composition containing a main agent of a matrix resin, a curing agent, and a solvent; and a drying step S7 of drying the matrix resin raw material composition impregnated into the fiber substrate in the impregnation step S5 (FIG. 1). The main agent is an epoxy resin. The curing agent is a PEG lignin derivative. The solvent includes a first solvent composed of a glycol ether, and a second solvent composed of an ether.

By using a glycol ether and an ether having high compatibility with the phenol group as a solvent for the PEG lignin derivative, the PEG lignin derivative can be sufficiently dissolved to obtain a varnish in a uniform mixed state. By using a glycol ether having a relatively high boiling point and an ether having a relatively low boiling point, it is possible to maintain a uniform varnish state in the impregnation step while volatilizing the solvent in a relatively short time even in the drying step under a relatively mild temperature condition.
(2) The boiling point of the first solvent is 120° C. or higher and 140° C. or lower. The boiling point of the second solvent is 25° C. or higher and 110° C. or lower. By using a solvent having a boiling point equal to or lower than the curing temperature (140° C.) of the matrix resin, the viscosity of the matrix resin can be maintained even after the drying step of volatilizing and removing the solvent. By using the second solvent having a boiling point of 110° C. or lower as a part of the solvent, the solvent can be volatilized and removed in a relatively short time even in the drying step under a relatively mild temperature condition. By using the first solvent having a boiling point of 120° C. or higher as a part of the solvent, it is possible to prevent volatilization of the entire amount of the solvent in the middle of the impregnation step and to maintain a uniform varnish state in the entire impregnation step.
(3) The prepreg production method further includes mixing steps S1 to S4 of mixing a main agent, a curing agent, and a solvent to obtain a matrix resin raw material composition (FIG. 1). The mixing steps S1 to S4 include a first mixing step S2 of mixing a curing agent and a first solvent, and a second mixing step S3 of mixing a mixed composition of the curing agent and the first solvent and a second solvent (FIG. 1). Among the first solvent composed of a glycol ether and the second solvent composed of an ether, the first solvent having an SP value close to 11.5 [cal/cm³]^{1/2}, which is the SP value of the phenol group, and having relatively high compatibility with the phenol group is first mixed, whereby the PEG lignin derivative can be suitably dissolved.
(4) The main agent is at least one of epoxidized soybean oil and sorbitol glycidyl ether. In addition to the curing agent using the PEG lignin derivative, a bioresin is used also as the main agent, so that utilization of the bioresin can be promoted.
(5) The first solvent is methyl cellosolve. The second solvent is THF. By using methyl cellosolve having particularly high compatibility with the phenol group as the first solvent, the PEG lignin derivative can be sufficiently dissolved to obtain a varnish in a uniform mixed state. Among the solvents having high compatibility with a phenol group, by using THE having a particularly low boiling point as the second solvent, the solvent can be volatilized and removed in a relatively short time even in the drying step under a relatively mild temperature condition.

The above embodiment can be combined as desired with one or more of the aforesaid modifications. The modifications can also be combined with one another.

According to the present invention, it becomes possible to maintain a uniform varnish state in the impregnation step.

Above, while the present invention has been described with reference to the preferred embodiments thereof, it will be understood, by those skilled in the art, that various changes and modifications may be made thereto without departing from the scope of the appended claims.

### Example 1

In Example 1, methyl cellosolve was used as the first solvent and THF was used as the second solvent in the prepreg production method of FIG. 1. In this case, it was confirmed that the state of the varnish (matrix resin raw material composition) at the time of completion of the mixing steps S1 to S4 was entirely transparent, and was in a uniform mixed state in which the main agent and the curing agent were sufficiently compatible with each other. It was confirmed that the state of the matrix resin composition at the time of completion of the drying step S7 was a uniform mixed state having viscosity in which the entire fiber substrate was impregnated and the main agent and the curing agent were not reacted. When the cut surface of the fiber-reinforced resin after completion of the press molding step S9 was observed, it was confirmed that there was no void inside. That is, when the solvent remains in the varnish at the time of completion of the drying step S7, the residual solvent is volatilized while the matrix resin is cured in the subsequent press molding step S9, so that voids are generated in the matrix resin of the fiber-reinforced resin. When there is no void inside the fiber-reinforced resin after completion of the press molding step S9, the solvent is completely volatilized and removed in the drying step S7.

### Example 2

In Example 2, THF was used as the first solvent and methyl cellosolve was used as the second solvent in the prepreg production method of FIG. 1. In this case, white turbidity was partially observed in the varnish (matrix resin raw material composition) at the time of completion of the mixing steps S1 to S4, but the entire fiber substrate was impregnated with the varnish (matrix resin raw material composition) in the impregnation step S5. When the cut surface of the fiber-reinforced resin after completion of the press molding step S9 was observed, it was confirmed that there was no void inside, and a fiber-reinforced resin in an appropriate state could be produced.

### Comparative Example 1

In Comparative Example 1, the first mixing step S2 and the second mixing step S3 of the prepreg production method of FIG. 1 were regarded as one solvent mixing step, and only THF was used as a solvent. That is, 100 parts (for example, 780 g) of THF was weighed, poured into the PEG lignin derivative weighed in step S1, added, and stirred with a mixer for 2 minutes. In this case, it was confirmed that the state of the varnish (matrix resin raw material composition) at the time of completion of the mixing step up to step S4 was entirely transparent, and was in a uniform mixed state in which the main agent and the curing agent were sufficiently compatible with each other. However, in the impregnation step S5, the solvent was volatilized and lost before the entire fiber substrate was impregnated with the varnish (matrix resin composition), the viscosity of the varnish increased, and the entire fiber substrate was not impregnated with the varnish.

### Comparative Example 2

In Comparative Example 2, the first mixing step S2 and the second mixing step S3 of the prepreg production method of FIG. 1 were regarded as one solvent mixing step, and only methyl cellosolve was used as a solvent. That is, 100 parts (for example, 780 g) of methyl cellosolve was weighed, poured into the PEG lignin derivative weighed in step S1, added, and stirred with a mixer for 2 minutes. In this case, it was confirmed that the state of the varnish (matrix resin raw material composition) at the time of completion of the mixing step up to step S4 was entirely transparent, and was in a uniform mixed state in which the main agent and the curing agent were sufficiently compatible with each other. However, when the cut surface of the fiber-reinforced resin after completion of the press molding step S9 was observed, voids were confirmed inside, and it was confirmed that the solvent was not completely volatilized and remained in the drying step S7.

### Comparative Example 3

In Comparative Example 3, the first mixing step S2 and the second mixing step S3 of the prepreg production method of FIG. 1 were regarded as one solvent mixing step, and only methyl ethyl ketone (MEK) (CH₃COC₂H₅) (SP value: 9.3 [cal/cm³]^{1/2}, boiling point: 79° C.) was used as a solvent. That is, 100 parts (for example, 780 g) of MEK was weighed, poured into the PEG lignin derivative weighed in step S1, added, and stirred with a mixer for 2 minutes. In this case, the PEG lignin derivative could not be sufficiently dissolved, and a varnish (matrix resin raw material composition) in a uniform mixed state could not be obtained.

### Comparative Example 4

In Comparative Example 4, the first mixing step S2 and the second mixing step S3 of the prepreg production method of FIG. 1 were regarded as one solvent mixing step, and only ethyl alcohol (ethanol) (C₂H₅OH) (boiling point: 78° C.) was used as a solvent. That is, 100 parts (for example, 780 g) of ethanol was weighed, poured into the PEG lignin derivative weighed in step S1, added, and stirred with a mixer for 2 minutes. Also in this case, the PEG lignin derivative could not be sufficiently dissolved, and a varnish (matrix resin raw material composition) in a uniform mixed state could not be obtained.

1. A prepreg production method, comprising:
an impregnation step of impregnating a fiber substrate with a matrix resin raw material composition containing a main agent of a matrix resin, a curing agent, and a solvent; and
a drying step of drying the matrix resin raw material composition impregnated into the fiber substrate in the impregnation step, wherein
the main agent is an epoxy resin, wherein
the curing agent is a polyethylene glycol lignin derivative, wherein
the solvent includes:
a first solvent composed of a glycol ether; and
a second solvent composed of an ether.

2. The method according to claim 1, wherein
a boiling point of the first solvent is 120° C. or higher and 140° C. or lower, wherein
a boiling point of the second solvent is 25° C. or higher and 110° C. or lower.

3. The method according to claim 1, further comprising:
a mixing step of mixing the main agent, the curing agent, and the solvent to obtain the matrix resin raw material composition, wherein
the mixing step includes:
a first mixing step of mixing the curing agent and the first solvent; and
a second mixing step of mixing a mixed composition of the curing agent and the first solvent, and the second solvent.

4. The method according to claim 1, wherein
the main agent is at least one of epoxidized soybean oil and sorbitol glycidyl ether.

5. The method according to claim 1, wherein
the first solvent is methyl cellosolve, wherein
the second solvent is tetrahydrofuran.

6. The method according to claim 1, wherein
the polyethylene glycol lignin derivative has a phenol group derived from lignin and a hydroxy group derived from polyethylene glycol and is a powder at normal temperature.

7. The method according to claim 1, wherein
a temperature condition of the drying step is set based on a boiling point of the solvent.

8. The method according to claim 1, wherein
a boiling point of the solvent is lower than a curing temperature at which a curing reaction between the epoxy resin and the polyethylene glycol lignin derivative starts.

9. A matrix resin raw material composition, comprising:
a main agent;
a curing agent; and
a solvent, wherein
the main agent is an epoxy resin, wherein
the curing agent is a polyethylene glycol lignin derivative, wherein
the solvent includes:
a first solvent composed of a glycol ether; and
a second solvent composed of an ether.
